(19) United States
(12) Patent Application Publication
(10) Pub. No.: US 2006/0155601 A1
(43) Pub. Date: Jul. 13, 2006

(54) Control of high technology advertising units

(75) Inventors: Clifford J. King, Fort Lauderdale, FL (US); Eugene Babchin, Adventura, FL (US); Jesse L. Quattlebaum, Deerfield, FL (US); Michael A. Arbitman, Pembroke Pine, FL (US); Stephen C. Flaherty, Las Vegas, NV (US); Steven M. Greene, Dresher, PA (US); Mathew Wheeler, Mayette, KS (US); Bobby J. Duck, Crossville, TN (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: Tomorrow's Technology Today, Inc., Holton, KS (US)

(21) Appl. No.: 11/292,020

(22) Filed: Dec. 1, 2005

Related U.S. Application Data
(60) Provisional application No. 60/632,197, filed on Dec. 2, 2004.

(51) Int. Cl. G06Q 30/00

(52) U.S. Cl. 705/14

(57) ABSTRACT

A method for distributing advertisement information in an advertisement system having a system server at a system site and a remote unit having a remote display device includes receiving the advertisement information by a cellular network by way of a first cellular modem to provide received advertisement information and transmitting the received advertisement information by way of the cellular network to provide transmitted advertisement information. The transmitted advertisement information from the cellular network received by way of a second cellular modem to provide transmitted advertisement information and a display is provided on the remote display device in accordance with the transmitted advertisement information to provide displayed advertisement information. The first cellular modem can be located at a user site further comprising applying the advertisement information to the first cellular modem by the user or the first cellular modem can be located at the system site further comprising applying the user advertisement information to the first cellular modem by the system server.

### CROSS-REFERENCE TO RELATED APPLICATIONS

This is a utility application based upon provisional application Ser. No. 60/632,197, filed on Dec. 2, 2004, entitled “Advertising System and Method”.

### BACKGROUND OF THE INVENTION

1. Field of Invention

This invention relates to the field of advertising and, in particular, to the field of electronic advertising.

2. Description of Related Art

Consumers are bombarded by hundreds of promotional advertisements every day. These advertisements include a combination of static posters, newspapers, magazines, radio, TV and electronic images. Advertisers must therefore endeavor to get above the advertising fray.

There is a consensus in the advertising industry that the most effective advertising is the advertising that occurs at the location where the product is sold. This is called Point of Sale (POS) advertising. Different techniques for POS advertising are known to those skilled in the art.

An advanced POS advertising method that is known in the art is displaying the advertisements electronically. This is accomplished, for example, by distributing advertisements by way of the public internet. In this method, advertisements can be uploaded to a central server by way of the public internet. Advertisements can then be transferred from the central server by way of the public internet to remote computers. Advertisements are then transferred from the remote computers to the advertisement display devices by way of the public internet. Known internet based systems utilize the public internet 100% of the time, even though confidential information can be obtained from the public internet.

It is well known that current systems utilizing the public internet to display POS advertisements electronically at remote locations are superior to prior systems that are based on static pictures and posters. Moving images are far superior to static pictures since they create much more interest and attention from the consumer.

However, the fact that the known systems for electronically displaying POS advertisements are dependent upon the public internet causes major problems. Experience has shown that internet based systems are subject to viruses, theft of information and compromising and manipulation of information. Additionally, internet based systems do not work when land phone lines are down even if they are configured through an independent antenna based network.

The possibility of existing internet based systems being compromised or hacked into and mischief occurring is troubling for a number of reasons. For example, hackers could replace business advertisements with pornography which could be seen by the public including children. Additionally, hackers could display advertisements with profanity for public view. Hackers could displace paying advertisements with unauthorized advertisements or replace a specific business advertisement with a competitor's advertisements. Furthermore, hackers could steal confidential client information placed on existing internet based systems.

Additionally, in order for existing internet based systems to work, customers must have a high speed internet line to upload the advertisements to the advertising units. If the customers are paying for usage, for example in the case of a T1 line, they are charged for the time that it takes for the upload.

Furthermore, the customer may need to share the high-speed line when advertisement loading occurs. Sharing in this manner can greatly reduce the internet speed. For example, a movie advertisement which is 4700 megabytes in size can take approximately eight hours to upload depending on speed of the connection. During that time, the speed of the client's internet will be reduced by approximately 75%. This can have a serious impact on the client's normal operations. Thus, the decrease in speed while loading that takes place can be more of a problem than the amount of time it takes to download. In order to eliminate this problem, the client must obtain a separate dedicated high-speed line for the download, resulting in additional cost.

U.S. Patent Application No. US2004/0172326 A1 by Yeo published on Sep. 2, 2004 describes a display system for electronically displaying advertisements at remote sites. The Yeo display system includes a number of displays positioned at the remote sites. The displays are adapted for wireless communication with end stations. A base station within the Yeo system receives display data representing information to be displayed. A controller within the base station controls the display of the information on the display devices. The base station and the display devices communicate via the internet in order to allow the display data to be transferred from the base station. The display system then displays the information as required by the controller.

U.S. Patent Application No. 2003/0105670 by Karakawa entitled “Electronic Poster System” published on Jun. 5, 2003 discloses an advertising tool that provides advertising content in digital form, thereby eliminating the need for manual work to change advertising content. In the Karakawa system display devices are placed at locations where consumers gather. Each display is connected to the internet by way of a personal computer. The personal computers are connected to a controller for controlling presentations on the displays. The internet is connected to an electronic poster site and to a mobile phone system. The mobile phones within the mobile phone system can thus be provided with a wireless connection to the server.

Therefore, the prior art for electronically displaying advertisements at remote sites including the transfer of data files, the loading of files and the actual displaying of the files does not teach doing so without using the public internet. The common thread that connects all of the prior art patents that display advertisements electronically at remote sites is the use of the public internet. This includes the transfer of data files, uploading files and displaying files. The present invention utilizes the cellular network with a cellular modem to accomplish these three critical steps instead of using the public internet.

All references cited herein are incorporated herein by reference in their entireties.

### SUMMARY OF THE INVENTION

A method for distributing advertisement information in an advertisement system having a system server at a system site and a remote unit having a remote display device includes receiving the advertisement information by a cellular network by way of a first cellular modem to provide received advertisement information and transmitting the received advertisement information by way of the cellular network to provide transmitted advertisement information. The transmitted advertisement information from the cellular network received by way of a second cellular modem to provide transmitted advertisement information and a display is provided on the remote display device in accordance with the transmitted advertisement information to provide displayed advertisement information. The first cellular modem can be located at a user site further comprising applying the advertisement information to the first cellular modem by the user or the first cellular modem can be located at the system site further comprising applying the user advertisement information to the first cellular modem by the system server. The method also includes providing scheduling information in accordance with the advertisement information for scheduling the display of the displayed advertisement information and transmitting the scheduling information to the remote server to provide transmitted scheduling information. The scheduling information is transmitted to the remote display device by way of the cellular network and the display is provided on the remote display device in accordance with the transmitted scheduling information. Determining at the remote unit whether further advertisement information is required at the remote unit in order to provide the display on the remote display device and requesting further advertisement information by the remote unit in accordance with the determining are also set forth.

The present invention can use a cellular network with a cellular modem and an on demand scheduler to display text, full motion video and sound advertisements and all combinations thereof at remote locations on multi advertisement delivery systems worldwide. The cellular network in the invention may be utilized to transfer data files from a centralized database with a cellular modem to remote advertisement delivery systems. Also, the centralized database in cooperation with a cellular modem permits advertisements to be displayed and changed at remote locations where the advertisement delivery systems are located. This can be entirely accomplished over a cellular network using cellular modems without any use of the public/private internet. However, in another embodiment the system can use only the public/private internet. In a further embodiment the public/private internet can be used only a small percentage of the time.

A client within the system of the present invention is provided with an on demand advertising capability by integrating High Tech Advertising (HTA) units into the centralized database through the use of a cellular network with a cellular modem and an on demand scheduler. An HTA can consist of but is not limited to a central processing unit (CPU), a cellular modem, X-10 server, X-10 receiver, projector, speakers and different types of display screens. The present invention provides flexible advertisement management capability. Advertisements can be managed in any order on a minute by minute, hour by hour, day by day, month by month, or year by year basis. Furthermore, advertisements can be scheduled for one or more specified days. Advertisements can also be scheduled to play over a period of time at different frequencies and time slots. The length of the advertisement schedule can be unlimited. For example, an advertisement schedule can be for more than a year in length if required by the client.

The on demand advertisement display capability at remote locations provided by the present invention through the use of the on demand schedule described above permits a client to target specific customers with specific advertisements. For example, a car dealership can target soccer moms with safety advertisements during the week around 10:00 AM when they are likely to be shopping at the dealership. The dealership can target the elderly with dependability advertisements on Friday night at 6:00 PM when they are likely to be shopping. Men can be targeted with car performance advertisements all day Saturday.

In addition to providing text, full motion video and sound advertisements the present invention can incorporate any combination of text, subtitling in any language, Power Point presentations, AVI, MPEG, JPEG, MOV and all other data files that can be recognized by a Linux media player.

Even though the present invention is designed to operate on a cellular network, it has the backward integration capability to run on a public or private internet such as a large area network (LAN) or a wide area network (WAN). This allows the present invention to perform multiple functions along multiple platforms.

Furthermore, the present invention permits customers to search through a database and individually design a product a vendor is selling. For example, based on database access provided in cooperation with the present invention a customer at a car dealership can design a personalized car. During this process the customer can be provided with targeted advertisements. While the specifications are being printed, the customer will watch an ad being displayed on the screen. The advertisements can be in any form described herein.

In a preferred embodiment the invention can be integrated with a point of sale (POS) terminal. While a credit card, debit card, coupon, ticket, phone card, etc. is processed or printed during a transaction the customer can view targeted advertisements in a display unit located at the POS terminal. When using an ATM machine and waiting for the transaction to be processed, the present invention software has the capability to display all data files recognized by a media player. Before a person is able to view an email attachment, the present invention software has the capability to display any data file before the attachment can be viewed. Instead of using static banners a web site has the capability to display an advertisement on demand with full motion video and sound. In the future, homes and businesses will be controlled by the use of a media center. The present invention has the capability to display while multiple processes are being completed by the media center. Also, the present invention has the capability to be integrated with digital billboards and light emitting diode (LED) displays.

The remote locations of the present invention can be provided with a touch screen or a key board and mouse or any other suitable device for use as a display interface to make purchases or make selections. In a preferred embodiment of the invention an entertainment system with a large display and a surround sound system can also be provided at the remote location. A directional speaker or a micro projector can be integrated with an HTA unit. Personal and micro computers can also be integrated into the remote locations.

In one embodiment of the invention advertisements can be transmitted from a computer by way of a private direct secure portal to a server. This use of the private internet in this embodiment can represent approximately one percent of the time that the system is in operation. The server is offline except when it receives transmissions through the private direct secure portal. Even though the server is offline for approximately 99% of the time it is provided with multi-layers of security. There is no public access to the direct secure portal and server.

The cellular systems used with the invention are more efficient, reliable and secure than internet based systems. For example, cellular systems are not subject to the damage caused by hackers and viruses on the internet. The chances of hackers hacking into this network or receiving a virus are the same as someone hacking into a cell phone or getting a virus on a cell phone. The ability to hack into the present invention is estimated to be less than 1% for the following reasons: the server runs on a secure Linux platform, advertisements are transmitted to the server via a private direct secure portal, the server has multi layers of security, transmissions to server represents less than 1% of the time, the server is on line less than 1% of the time, transmission of data files from centralized database to remote units is via the cellular network, past experience has indicated that hacking into a cellular network is virtually impossible, hacking into the cellular network is equivalent to hacking into a cell phone, which is extremely difficult to do.

Furthermore, the present invention can continue to operate when the land phone lines are down and when normal cell phone lines are busy. Even if the internet is not responding or if cellular phones are busy, the cellular modem operates along a separate frequency so the transmission will still materialize. For example, when a customer has no dial tone, or if their cellular phone is receiving a busy signal, they can still withdraw money from an ATM machine. The present invention's cellular modem operates on a frequency similar to the ATM. Consequently, the present invention will continue to operate in a normal manner when there is no dial tone, no internet, and the cell phones are receiving a busy signal.

### BRIEF DESCRIPTION OF SEVERAL VIEWS OF THE DRAWINGS

The invention will be described in conjunction with the following drawings in which like reference numerals designate like elements and wherein:

FIG. 1 is a block diagram representation of the present invention for loading data files by way of a secure direct private portal. FIG. 1 is a block diagram representation

FIG. 2 is a block diagram representation of a system for loading data files by way of a cellular network.

FIG. 3 is a block diagram representation of a system for loading data files from a centralized database/server to a remote unit by way of a cellular network.

FIG. 4 is a block diagram representation of a system for sending data files from a remote computer by way of a server to a receiver to display data.

FIG. 5 is a block diagram representation of an overview of the system of the present invention for displaying advertisements at remote locations.

FIGS. 6A-D are more detailed block diagram representations of the system of the present invention utilizing the cellular network with a real time scheduler to display advertisements at remote locations.

FIG. 7 is a detailed block diagram representation of an alternate embodiment of the system of FIGS. 6A-D utilizing the cellular network with a real time scheduler to display advertisements at remote locations.

### DESCRIPTION OF THE PREFERRED EMBODIMENT

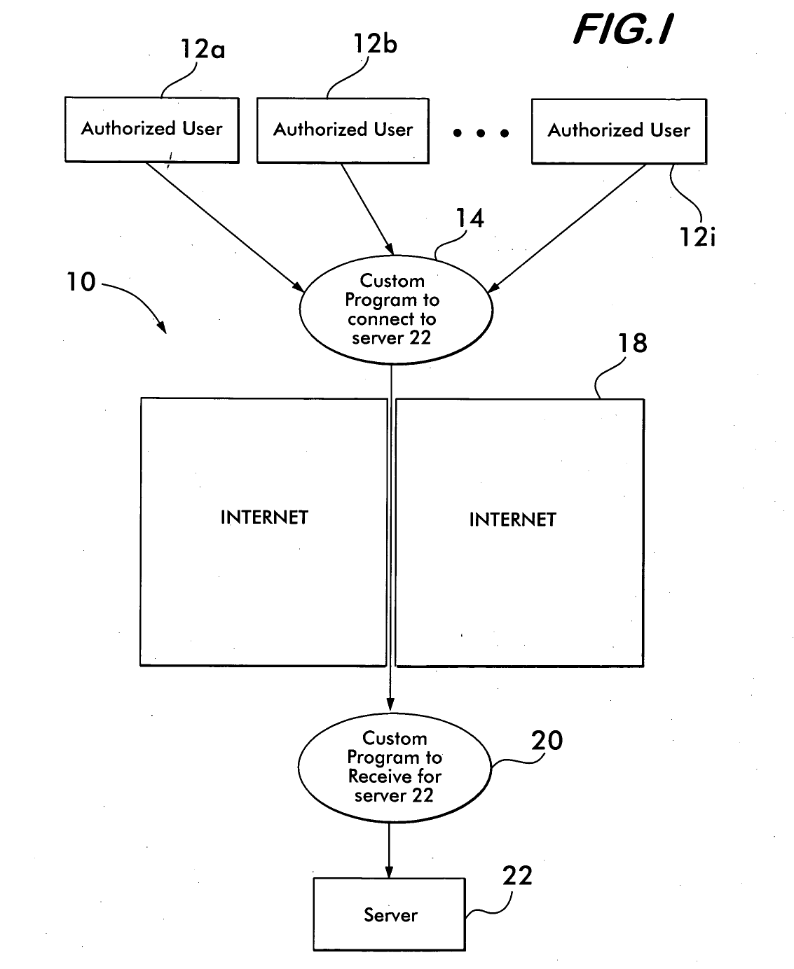

Referring now to FIG. 1, there is shown a block diagram representation of the data files loading system 10 of the present invention for loading data files from authorized users 12a-i to a centralized database/server 22 by way of a secure direct private portal of the private internet through the public internet 18. The data file loading system 10 can be adapted to receive data files such as advertisement information data files from any number of authorized users 12a-i. Furthermore, the authorized users 12a-i can be located anywhere on the globe that is serviced by the internet 18.

The authorized users 12a-i are provided with a custom program 14 configured on their personal computers in order to permit them to connect to the centralized database/server 22 by way of the secure direct private portal.

The use of the custom program 14 provides security for the authorized users 12a-i because of the protection that can be designed into the custom program 14. After a transfer of data files has been completed the custom program 14 is no longer required and the secure portal can be terminated.

The centralized database/server 22 is provided with the custom program 20 in order to receive the data files from the custom program 14 by way of a direct secure private portal to the private internet 18. Once the files have been transferred to the centralized database/server 22 the custom program 20 can be terminated, thereby terminating the portal.

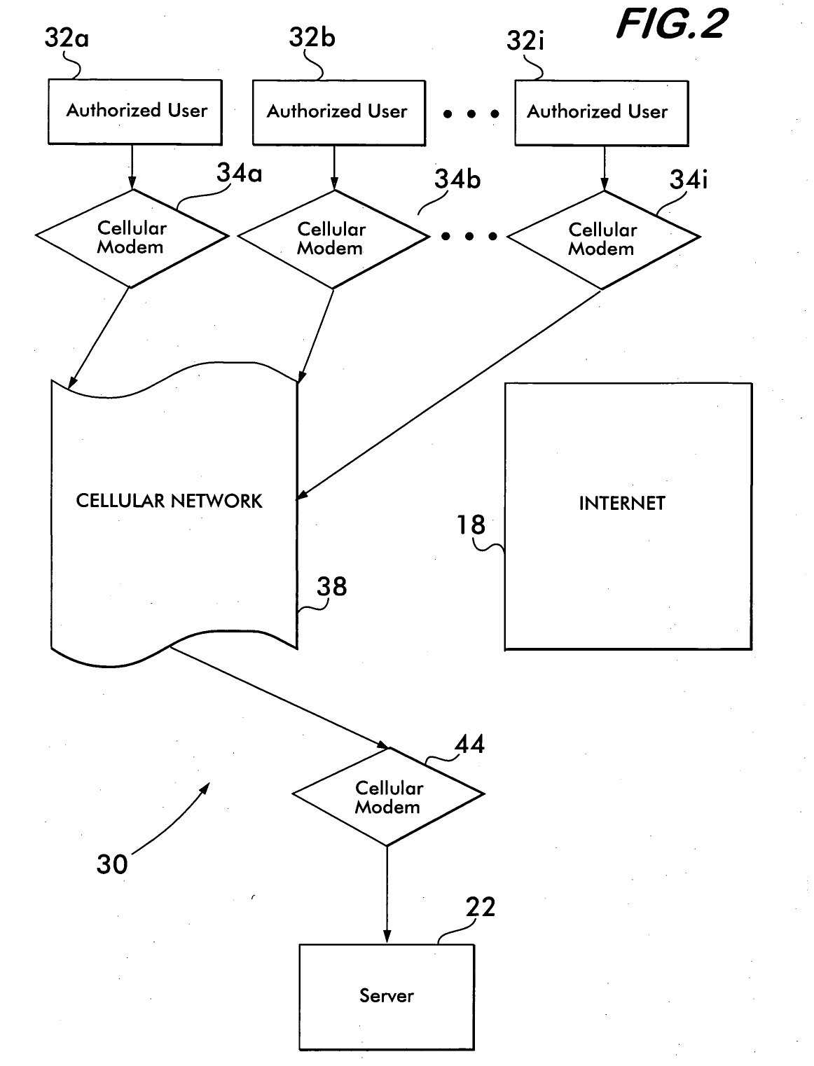

Referring now to FIG. 2, there is shown a block diagram representation of the data files loading system 30 of the present invention for loading data files from the authorized users 32a-i by way of a cellular network 38. The data files loading system 30 can be used to perform the steps previously described in connection with the present invention loading system 10 (FIG. 1), however providing more secure transmission of the data files. The data file loading system 30 can be adapted to receive data files from any number of authorized users 32a-i as previously described with respect to the data files loading system 10 (FIG. 1). Furthermore, the authorized users 32a-i can be located anywhere that is serviced by the cellular network 38.

The authorized users 32a-i of the data files loading system 30 can be coupled to the cellular network 38 by way of respective cellular modems 34a-i. The cellular modems 34a-i can transmit the data files from the authorized users 32a-i to the cellular network 38. The cellular network 38 can transmit the data files to the cellular modem 44. The cellular modem 44 can then transmit the information received by way of the cellular network 38 to the centralized database/server 22.

Each cellular modem 34a-i of the data files loading system 30 can have a dedicated cellular number. In this manner, the cellular network 38 can serve as a direct cellular portal from each of the cellular modems 34a-i to the cellular modem 44. This process can be referred to as a direct connect of the authorized users 32a-i. Note that the public/private internet 18 is not utilized in this system and method.

When the centralized database/server 22 receives the data files from the cellular modem 44 or the custom program 20 (FIG. 1) it can store the received data files for scheduled display. Additionally, the centralized database/server 22 can prepare the received data files for transmission to remote advertising units as described in more detail below. Thus, data files can be transmitted to the centralized database/server 22 for storage and preparation either by way of the present invention's data file loading system 10 (FIG. 1) using the private internet 18 or, in accordance with the present invention, by way of the data files loading system 30 using the cellular network 38 (FIG. 2).

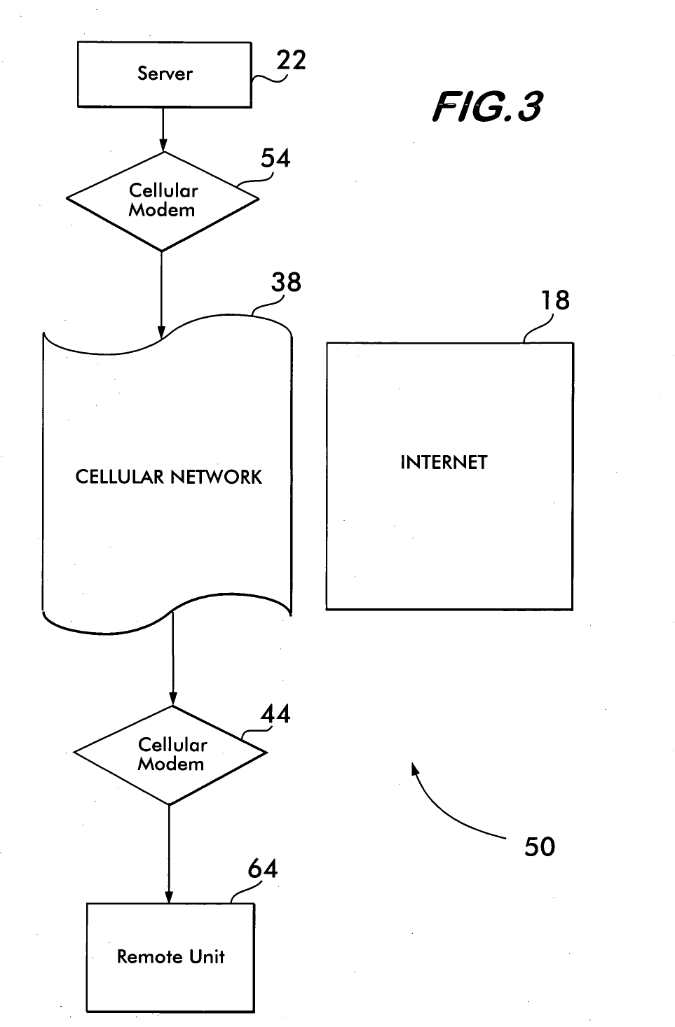

Referring now to FIG. 3, there is shown a block diagram representation of the data files loading system 50. The data files loading system 50 can transmit the data files of the authorized users 12a-i or the authorized users 32a-i as received by way of the data files loading systems 10 (FIG. 1), 30 (FIG. 2) to a remote unit 64 for display. The data files are transmitted to the remote unit 64 by way of cellular modem 54, the cellular network 38 and the cellular modem 44. The cellular modems 44, 54 can be any type of cellular modems known to those skilled in the art. Note that the public/private internet 18 is not utilized in the data files loading system 50.

Within the data files loading system 50 the cellular network 38 can thus serve as a direct cellular portal from the cellular modem 54 to the remote unit 64 by way of the cellular modem 44. In a preferred embodiment of the invention the cellular modems 44, 54 can have dedicated cellular numbers. As previously described, this process can be referred to as direct connect.

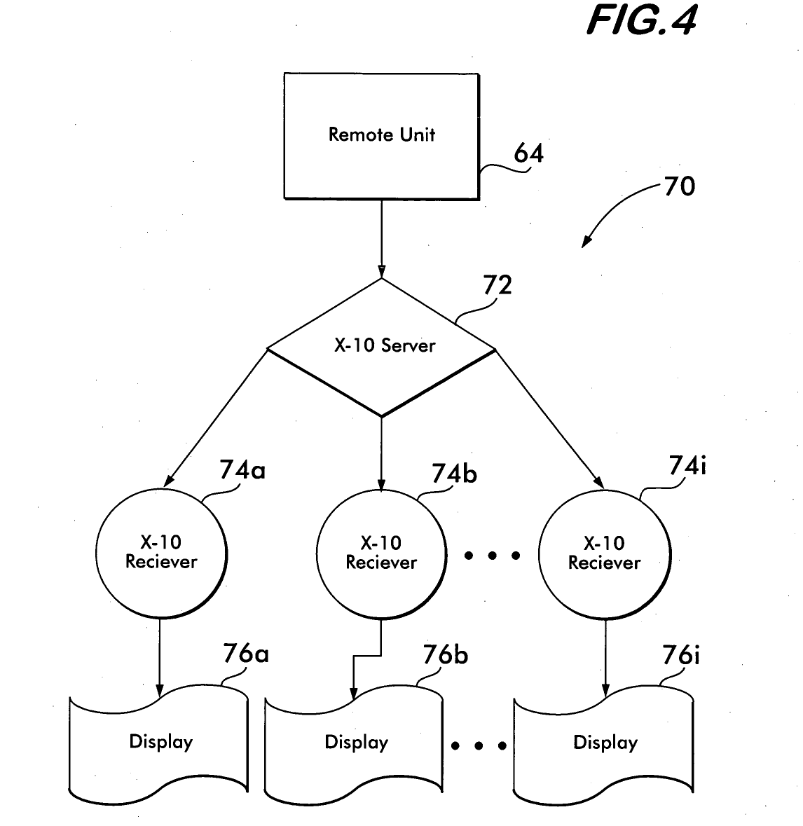

Referring now to FIG. 4, there is shown a block diagram representation of the data files display system 70. The data files display system 70 can be used for displaying data files transmitted to the remote unit 64 by way of the data files loading systems 30 (FIG. 2), 50 (FIG. 3). The remote unit 64 can send the received data files to the display units 76a-i by way of an X-10 server 72 and the X-10 receivers 74a-i for display. The X-10 server 72 can be connected directly to a central processing unit (not shown) for processing the information transmitted to it by the remote unit 64.

When the X-10 server 72 receives the data files from the remote unit 64 the data files can be sent simultaneously to any number of X-10 receivers 74a-i configured to run with the X-10 server 72 over a specified geographic range. The transmissions of the data files to the X-10 receivers 74a-i are preferably performed wirelessly. In another embodiment of the data files of the display system 70, the display units 76a-i can be hard wired to the X-10 receivers 74a-i in order to transmit the data files to their specified display unit 76a-i.

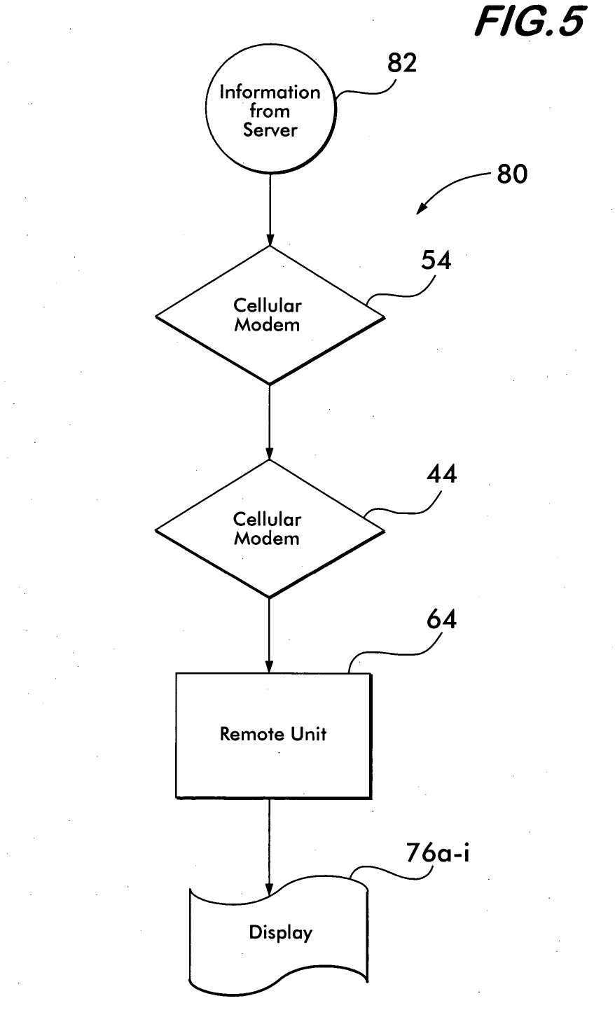

Referring now to FIG. 5, there is shown a block diagram representation of the overview 80 of the system and method of the present invention. Those skilled in the art will understand that only selected features of the system and method of the present invention are represented in the overview 80 in order to simplify the drawing for illustrative purposes.

The system and method represented by the overview 80 is adapted to load data files from the authorized users 12a-i (FIG. 1), 32a-i (FIG. 2) by way of the server 22 (FIGS. 1, 2 and 3) to remote units such as the remote unit 64. The data file information 82 from the server 22 can be transmitted by way of the cellular network 38 and the cellular modems 34a-i, 54. The cellular modems 34a-i, 54 can have dedicated cellular numbers. Under these circumstances the cellular network 38 can serve as a direct cellular portal from one cellular modem at the side of server 22 having a dedicated cellular number to the cellular modem at the side of remote unit 64 that also has a separate dedicated cellular number. This process can also be referred to as direct connect. Use of the public/private internet 18 is not required during this process.

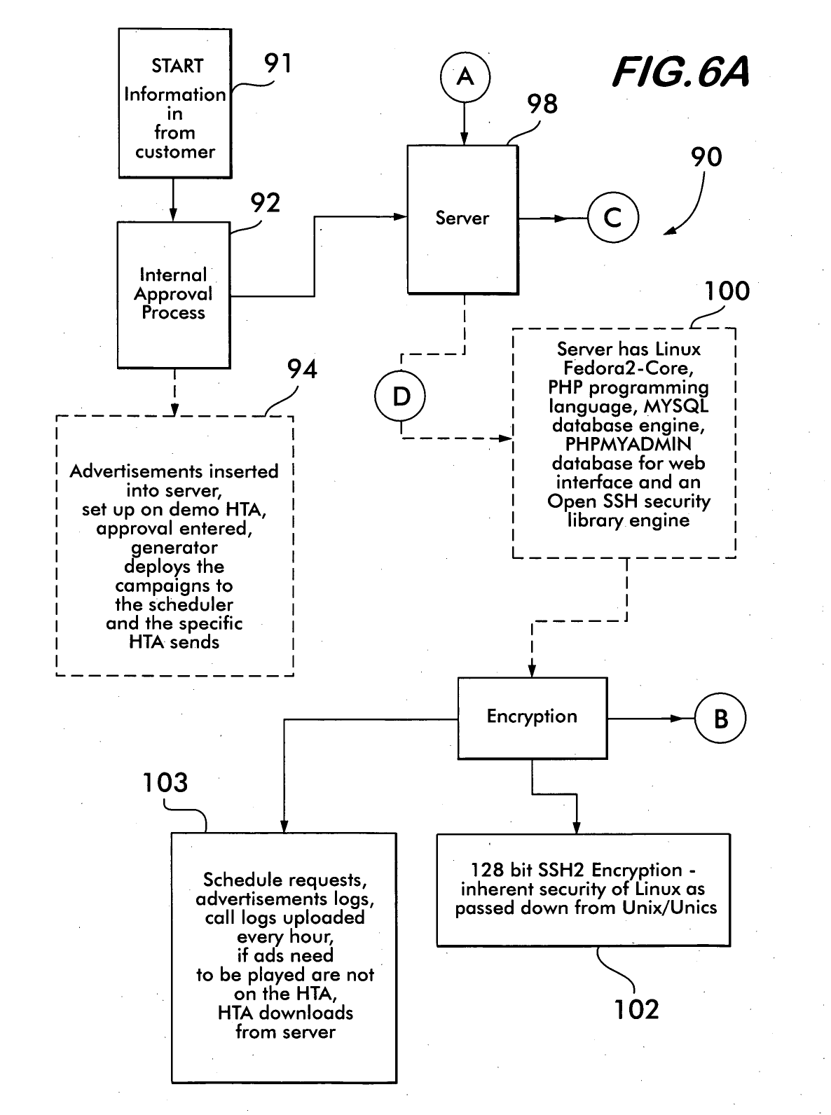

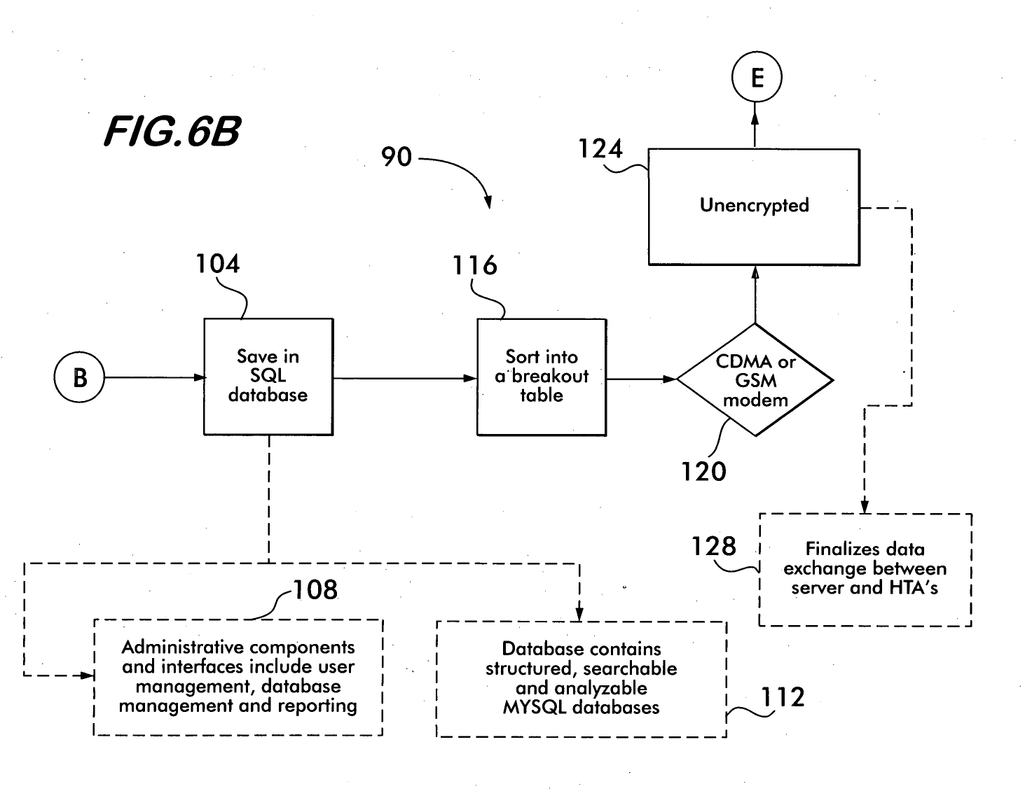

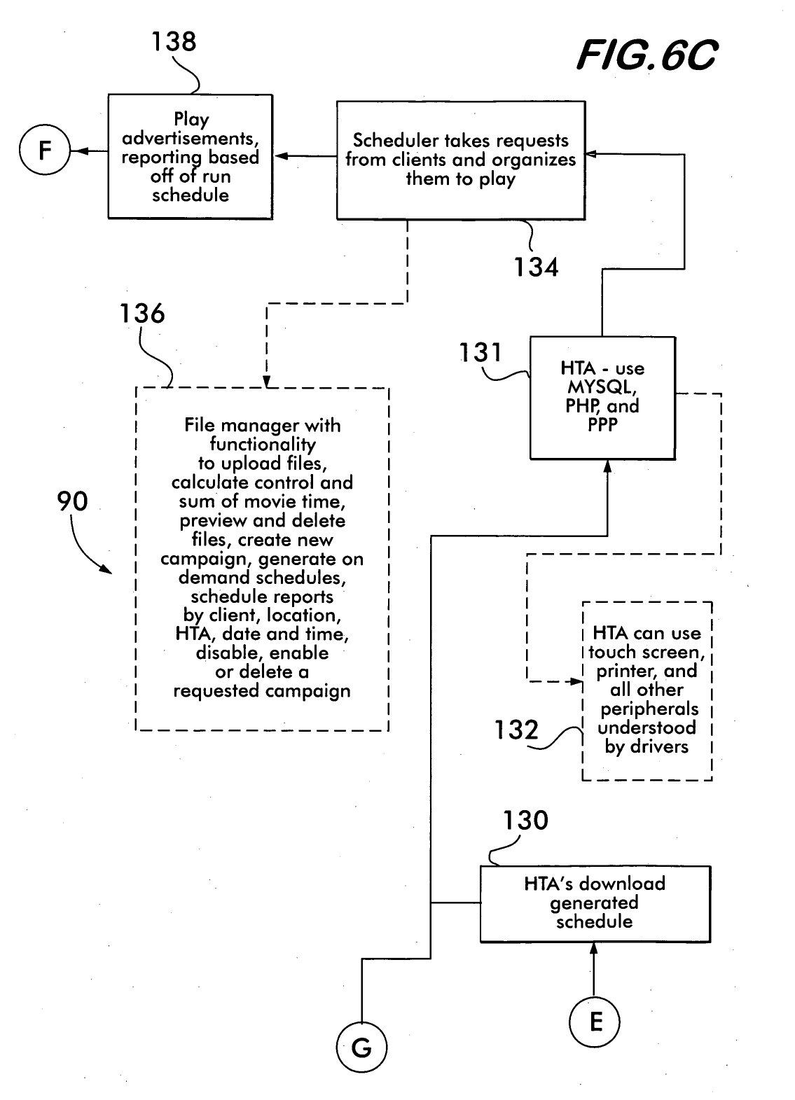

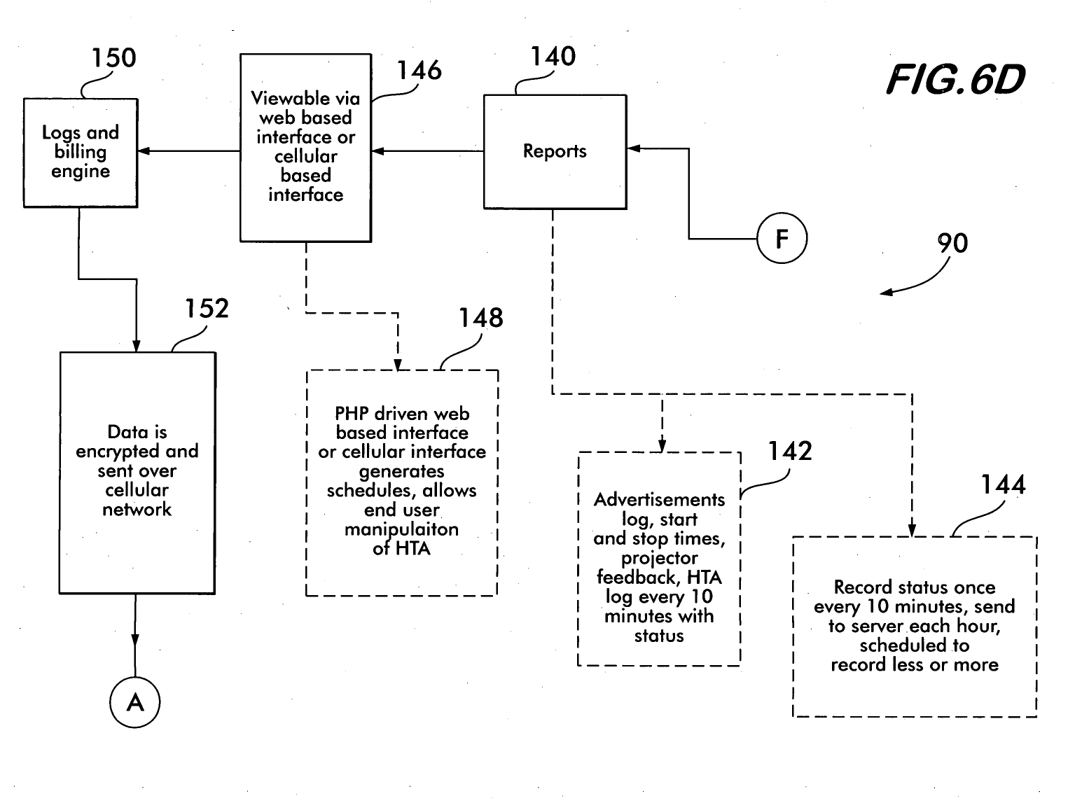

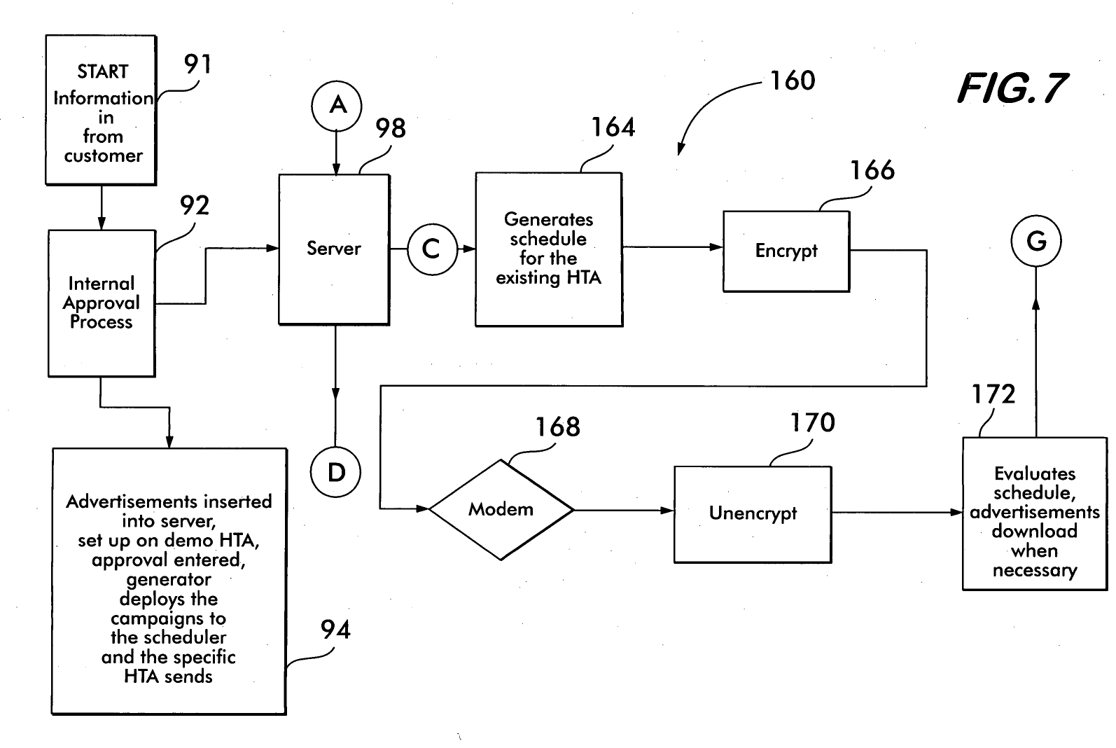

Referring now to FIGS. 6A-C, there are shown more detailed block diagram representations of an overview 90 of the system and method of the present invention. The system overview 90 receives the data files from the cellular network 38 and is used to display on demand advertisements on remote units such as the remote unit (FIG. 4). The system overview 90 (FIG. 6A) shows the operations performed by a new HTA which is performing the operations of the system of the invention for the first time. During the first execution of the inventive method, the new HTA must download necessary files which can be used subsequently as described in more detail below with respect to system overview 160 (FIG. 7). The files that are downloaded are the custom scheduler list, or play list and the necessary data files to complete that play list.

As shown in start block 91 of FIG. 6A within the system overview 90, information is received from a customer for entry into the system and method of the invention. The information received in this manner can be in the form of a data file format, a video file format or any other format known to those skilled in the art and recognized by a media player within the system. The received information can go through an internal approval process as shown in block 92 to ensure that the advertisements are of suitable content and to make any other determinations required as shown in information block 94.

In response to the received information, advertisements and other data can be inserted into the server as shown in block 98 and described in information block 94. The data can also be set up on a demonstration HTA unit. The data can then be entered into an advertising campaign. The campaigns are generated and deployed to the scheduler as also described in information block 94. The schedule can be sent to a specified HTA unit.

After the operations of the internal approval process of block 92 and information block 94, the data files can be sent to the server as shown in block 98 and previously described with respect to the data file loading systems 10 (FIG. 2), 30 (FIG. 3). The server can have a Linux Fedora2-Core, PHP programming language as described in information block 100. It can also have a MYSQL database engine, a PHPMYADMIN database web interface and an OpenSSH security library engine or any other suitable packages known to those skilled in the art.

The data can be encrypted and the system overview 90 can proceed as described in information block 102. The encryption can be a 128 bit SSH2 encryption which is the inherent security of Linux as passed down from Unix/Unics or any other suitable encryption process. The data that is encrypted during the encryption process includes but is not limited to the schedule request advertisement logs, call logs. The information can be uploaded every hour. If advertisements to be played are not on the HTA unit, the HTA downloads the data files from the server as shown in block 103. Execution of the system overview 90 can then proceed from FIG. 6A to FIG. 6B by way of page connectors B.

With reference to FIG. 6B of the system overview 90, the encrypted data can then be saved in a database such as a SQL database as shown in block 104. The administrative component and interfaces for entry into the SQL databases can include but are not limited to user management, data base management and reporting as shown in information block 108. The SQL database set forth in block 104 can contain any structured, searchable and analyzable MYSQL databases as described in information block 112. The SQL database can be sorted into breakout tables as shown in block 116 within the system overview 90.

The information can then be sent by way of a cellular modem to a specified HTA unit as previously described with respect to the data files loading system 50 (FIG. 3). The cellular modem can operate on a CDMA or GSM network or any other kind of wireless network as shown in block 120. If necessary, the data can be unencrypted as shown in block 124. The unencryption finalizes the data exchange between the server and the HTA units as described in information block 128. Execution of the system overview 90 can then proceed from block 124 of FIG. 6B to FIG. 6C by way of page connectors E.

With reference to FIG. 6C of the system overview 90, the HTA units can then download the generated schedule as shown in block 130. The HTA unit can use MYSQL, PHP or PPP customized programs as shown in block 131. An example of customized programs could be a Linux media player, Linux scheduler, or a Linux operating system. As described in information block 132 the HTA units can use touch screens printers or any other peripherals that can be recognized via a computer with the use of drivers or custom drivers. The scheduler can then receive requests from the client and organize them for display at HTA units as shown in block 134.

As described in information block 136 the file manager of the system overview 90 has the functionality to up load data files, calculate the control sum and movie time, preview and delete data files and create a new campaign. The file manager can also generate on demand schedules, schedule reports by client, location, HTA, date and time as well as disable, enable or delete a requested campaign as also described in information block 136. In block 138 the HTA unit can display the advertisements and creates a report based on the run schedule. Execution of the system overview 90 can then proceed from block 138 of FIG. 6C to FIG. 6D by way of page connectors F.

With reference to FIG. 6D of the system overview 90, reports can then be generated by the HTA as shown in block 140. The reports generated by the HTA consist of but are not limited to the advertisement logs, start and stop times and projector feedback as described in information block 142. In one preferred embodiment of the invention the HTA unit can record the status every ten minutes as also shown in information block 142. The status can be sent to the server each hour as shown in information block 144 or at any other time interval. As shown in block 146 the reports can be made viewable by way of a web based interface or a cellular network based interface.

As described in information block 148 a PHP driven web based interface or a cellular interface can generate all schedules and allows end user manipulation of the HTA unit. The logs and billing engines can then be executed as shown in block 150. The data can be encrypted and sent back to the server over the cellular network as shown in block 152. Execution of the system overview 90 can then proceed from block 152 of FIG. 6D to block 98 of FIG. 6A by way of page connectors A and the process can start again.

Referring now to FIG. 7, there is shown a block diagram representation of the overview 160 of the system and method of the present invention wherein a cellular network is used to display on demand advertisements at remote locations. Overview 160 shows the operations performed by an HTA after is has executed the method of the invention at least once and obtained all of the required software from the centralized database/server 22.

As shown in block 91 of the system overview 160, information is received from a customer for entry into the system. The information received in this manner can be in the form of a data file, a video file or any other format known to those skilled in the art and recognized by a media player within the system. As previously described with respect to system overview 90 the received information can go through an internal approval process to ensure that the advertisements are of suitable content and to make any other determinations required as shown in block 92.

In response to the received information, advertisements can be inserted into the server. The information can also be set up on a demonstration HTA unit as shown in information block 94. After the approval process it is enter into a campaign. The campaigns are generated and deployed to the scheduler as described in information block 102 (FIG. 6A) of the system overview 90. The schedule can be sent to a specified HTA unit. After the internal approval process the data files can be sent to the server as shown in block 98 and described with respect to the data file loading systems 10 (FIG. 1), 30 (FIG. 2). At block 164 of the system overview 160 the server can generate a new schedule for the existing HTA unit.

The data can be encrypted, sent by way of the cellular modem and unencrypted as shown in diamonds 166, 168, 170. As shown in block 172 the HTA custom program evaluates the schedule and downloads the advertisements when necessary. Execution of the system overview 160 can then proceed to blocks 130, 131 of the system overview 90 in FIG. 6C as indicated by connector C and continue with the system overview 90 as previously described.

It will be understood that the system and method of the present invention can be practiced with any shape or size holo screens or with any other screens. Furthermore, the screens can be clear, dark or light. Any microcomputer, for example the Sony U Series microcomputer, may be used. A Mitsubishi micro projector, or any projector known to those skilled in the art, can be used. Additionally, any generic cellular modem, X10 server or receiver, plasma TV, digital billboard, LED display, liquid crystal display (LCD) screen or other input that has either a monitor connector or RCA cables can be used.

While the invention has been described in detail and with reference to specific examples thereof, it will be apparent to one skilled in the art that various changes and modifications can be made therein without departing from the spirit and scope thereof.

What is claimed is:

1. A method for distributing advertisement information in an advertisement system having a system server at a system site and a remote unit having a remote display device, comprising:
receiving said advertisement information by a cellular network by way of a first cellular modem to provide received advertisement information;
transmitting said received advertisement information by way of said cellular network to provide transmitted advertisement information;
receiving said transmitted advertisement information from said cellular network by way of a second cellular modem to provide transmitted advertisement information; and
providing a display on said remote display device in accordance with said transmitted advertisement information to provide displayed advertisement information.

2. The method for distributing advertisement information of claim 1, wherein said first cellular modem is located at a user site further comprising applying said advertisement information to said first cellular modem by said user.

3. The method for distributing advertisement information of claim 1, wherein said first cellular modem is located at said system site further comprising applying said user advertisement information to said first cellular modem by said system server.

4. The method for distributing advertisement information of claim 1, further comprising:
providing scheduling information in accordance with said advertisement information for scheduling said display of said displayed advertisement information; and
transmitting said scheduling information to said remote server to provide transmitted scheduling information.

5. The method for distributing advertisement information of claim 4, further comprising transmitting said scheduling information to said remote display device by way of said cellular network.

6. The method of distributing advertisement information of claim 4, further comprising providing said display on said remote display device in accordance with said transmitted scheduling information.

7. The method of distributing advertisement information in claim 1, further comprising:
determining at said remote unit whether further advertisement information is required at said remote unit in order to provide said display on said remote display device; and
requesting further advertisement information by said remote unit in accordance with said determining.

8. The method of distributing advertisement information in claim 7, further comprising requesting said further advertisement information from said system server by said remote unit.

9. The method of distributing advertisement information in claim 1, further comprising altering said advertisement information to provide altered advertisement information.

10. The method of distributing advertisement information in claim 9, further comprising altering said advertisement information by a user of said advertisement system to provide user altered advertisement information.

11. The method of distributing advertisement information in claim 10, further comprising transmitting said user altered advertisement information by way of said cellular network

12. The method of distributing advertisement information in claim 11, further comprising receiving said user altered advertisement information by said second cellular modem.

13. The method of distributing advertisement information in claim 12, further comprising providing a further display on said remote display device in accordance with said user altered advertisement information.

14. The method of distributing advertisement information in claim 9, further comprising providing an altered display at said remote display device in accordance with altered content information.

15. The method of distributing advertisement information in claim 9, wherein said altering comprises terminating said display on said remote display device.

16. The method of distributing advertisement information in claim 1, further comprising providing by said remote unit a remote unit report regarding said display on said remote display device.

17. The method of distributing advertisement information in claim 16, further comprising transmitting said remote unit report to said system server by said remote unit.

18. The method of distributing advertisement information in claim 17, comprising altering said advertisement information in accordance with said remote unit report to provide altered advertisement information.

19. The method of distributing advertisement information in claim 16, wherein said remote unit report comprises display start time information.

20. The method of distributing advertisement information in claim 16, wherein said remote unit report comprises projector feedback information.

21. The method of distributing advertisement information in claim 4, further comprising altering said scheduling information to provide altered scheduling information.

22. The method of distributing advertisement information in claim 21, wherein said altered scheduling information comprises time of day information.

23. The method of distributing advertisement information in claim 21, wherein said altered scheduling information comprises date of display information.

24. The method of distributing advertisement information in claim 21, wherein said altered scheduling information comprises duration of display information.

25. The method of distributing advertisement information in claim 21, wherein said advertisement system includes a plurality of remote display devices and said display is provided on a first remote display device of said plurality of remote display devices further comprising displaying said advertisement information on a second remote display device of said plurality of remote display devices in accordance with said altered scheduling information.

26. The method of distributing advertisement information in claim 1, further comprising transmitting said advertisement information by way of a direct connect secure portal.

27. The method for distributing advertisement information of claim 1, wherein said system includes system software further comprising integrating said system software into a point of sale terminal.

28. The method for distributing advertisement information of claim 1, further comprising providing said display on an ATM.

29. The method for distributing advertisement information of claim 1, further comprising providing said display in accordance with a display of an email attachment.

30. The method for distributing advertisement information of claim 1, further comprising providing said display on a web page to provide a web page display.

31. The method for distributing advertisement information of claim 30, wherein said web page display comprises a video display.

32. The method for distributing advertisement information of claim 1, further comprising providing said display by a media center.

33. The method for distributing advertisement information of claim 1, further comprising:
providing to a customer access to a database at a point of sale; and
customizing a product by said customer in accordance with data in said database.

34. The method for distributing advertisement information of claim 31, further comprising providing said display to said customer while said customer is customizing said product.

35. The method for distributing advertisement information of claim 1, wherein said display comprises subtitles.

36. The method for distributing advertisements information of claim 1, wherein said display comprises digital billboards and LED displays.
